(19) United States
(12) Patent Application Publication
(10) Pub. No.: US 2026/0082220 A1
(43) Pub. Date: Mar. 19, 2026

(54) BROWSER EXTENSION AUTHENTICATION

(71) Applicant: Open Text Inc., Menlo Park, CA (US)

(72) Inventors: Rahul Singh, Bengaluru (IN); Himanshu Arunkumar Singh, Vadodara (IN); Lekha Pai Bantwal Hebbalsinakatte, Mangalore (IN); Kumar Rohan, Bokaro Steel City (IN)

(21) Appl. No.: 18/886,819

(22) Filed: Sep. 16, 2024

(51) Int. Cl. H04W 12/06

(52) U.S. Cl. CPC H04W 12/06

(57) ABSTRACT

A computer-implemented method for browser extension authentication. A browser extension of a web browser on a mobile device requests an authentication key from a remote service. The browser extension receives the authentication key from the remote service. The browser extension provides the authentication key to a native mobile application on the mobile device. The native mobile application sends the remote service data to be mapped to the authentication key as mapped data. The browser extension requests the mapped data corresponding to the authentication key and receives the mapped data. The browser extension authenticates using the mapped data received from the remote service.

### TECHNICAL FIELD

This disclosure relates to web browser extensions. More particularly, this disclosure relates to authenticating browser extensions with online services.

### BACKGROUND

Many users use mobile applications to access cloud services. In a typical scenario, a user configures a mobile application to authenticate with a cloud service using authentication credentials, such as a username or password. In some implementations, the end-user provides credentials each time the mobile application is launched. In others, the end-user provides credentials when the mobile application is installed and further authentication between the mobile application and the service is transparent to the end-user.

In some cases, a user may install a browser extension that leverages a mobile application or the same or related cloud services as a mobile application. The mobile operating system or other component of a mobile device, however, may prevent the mobile application from sharing authentication credentials for the cloud service with the browser extension. Consequently, if the browser extension requires authentication, the end-user may have to redundantly input their credentials to the web browser, even when the related mobile application has already authenticated with the cloud service.

As such, there is a desire for improved mechanisms for authenticating mobile browser extensions.

### SUMMARY

One general aspect of the present disclosure includes a computer-implemented method for browser extension authentication. The computer-implemented method includes a browser extension of a web browser on a mobile device requesting an authentication key from a remote service and receiving the authentication key from the remote service. The browser extension may provide the authentication key to a native mobile application on the mobile device. The mobile application sends data to be mapped to the authentication key to the remote service. For example, the mobile application, according to one embodiment, sends a unique identifier for mapping to the authentication key.

The method may further include the browser extension requesting and receiving the mapped data corresponding to the authentication key. The browser extension can authenticate using the mapped data received from the remote service. Other embodiments of this aspect include corresponding computer systems, apparatus, and computer programs recorded on computer storage devices, each configured to perform the actions of the methods.

The computer-implemented method may include the native mobile application sending a data mapping request to the remote service to map the unique identifier to the authentication key, where the data mapping request includes the authentication key and the unique identifier. In some embodiments, the mapping request includes additional user specific or native mobile application specific data for mapping to the authentication key.

The computer-implemented method may include the browser extension requesting the authentication key from the remote service in response to a user navigating to the web browser on the mobile device.

Authenticating using the mapped data received from the remote service may include sending an authentication request to the remote service. The authentication request includes the authentication key and the mapped data. For example, in one embodiment, the authentication request includes the authentication key, a unique identifier, and additional authentication data.

The computer-implemented method may include the remote service generating the authentication key in response to the browser extension requesting the authentication key. The computer-implemented method may include the remote service mapping the additional data to the authentication key to generate the mapped data. For example, the computer-implemented method may include mapping the unique identifier and other authentication data to the authentication key. Implementations of the techniques described may include hardware, a method or process, or computer software on a computer-accessible medium.

Another general aspect includes a computer program product that comprises a non-transitory computer-readable medium storing thereon data embodying a browser extension executable by a mobile device. According to one embodiment, the browser extension is a browser security extension executable to read webpage content returned by websites to a web browser.

The browser extension may comprise instructions executable for sending a request for an authentication key to a remote service, receiving the authentication key from the remote service, and providing the authentication key to a native mobile application on the mobile device. The native mobile application sends a data mapping request to the remote service to map authentication data, such as a unique identifier and any other authentication data, to the authentication key. The browser extension may further include instructions executable for requesting the mapped data from the remote service using the authentication key. The mapped data includes data provided by the native mobile application, such as a unique identifier and any other mapped authentication data. The browser extension may also include instructions for authenticating using the mapped data received from the remote service. Other embodiments of this aspect include corresponding computer systems, apparatus, and computer-implemented methods.

According to one embodiment, authenticating using the mapped data received from the remote service includes the authentication key and mapped authentication data, such as a unique identifier in one embodiment.

Another general aspect of the present disclosure includes a computer program product comprising a non-transitory, computer-readable medium data embodying a native mobile application executable by a mobile device. The native mobile application comprises instructions for receiving an authentication key from a browser extension on the mobile device, the authentication key to the native mobile application, and associating additional authentication data with the authentication key. For example, the native mobile application associates a unique identifier and any other authentication data with the authentication key. The native mobile application comprises instructions for sending authentication data associated with the authentication key to a remote service for use by the browser extension in authenticating using mapped data received from the remote service. Other embodiments of this aspect include corresponding computer systems, apparatus, and computer-implemented methods.

Another general aspect of the present disclosure includes a system for browser extension authentication. The system includes a mobile device and a server computer. The mobile device comprises a mobile device processor and a mobile device memory storing applications. The mobile device applications include a web browser having a browser extension and a native mobile application. According to one embodiment, the browser extension is executable by the mobile device processor and includes instructions for sending a request for an authentication key to a remote service, receiving the authentication key from the remote service, and providing the authentication key to the native mobile application. According to one embodiment, the native mobile application sends a data mapping request to the remote service to map authentication data, such as a unique identifier, to the authentication key. The browser extension may include instructions executable for requesting mapped data using the authentication key, and authenticating using the mapped data received from the remote service. The mapped data includes unique identifier and may include other authentication data.

The native mobile application, according to one embodiment, is executable by the mobile device processor and includes instructions for receiving the authentication key from the browser extension and providing authentication data to the remote service for mapping to the authentication key as the mapped data. According to one embodiment, the authentication data includes a unique identifier. The authentication data may also include other types of data.

According to one embodiment, the native mobile application includes instructions for sending a data mapping request to the remote service to map the authentication data to the authentication key. The data mapping request may include the authentication data. The authentication data may include at least one of user specific data or data specific to the native mobile application. According to one embodiment, the authentication data includes a unique identifier.

The server, according to one embodiment, is communicatively coupled to the mobile device by a network. The server includes a server processor and a server memory storing code executable by the server processor to provide the remote service. The code for the remote service may include instructions for generating the authentication key, returning the authentication key to the browser extension, receiving the authentication data and the authentication key from the native mobile application, mapping the authentication data to the authentication key, providing the authentication key and the mapped data to the browser extension, and authenticating the browser extension using the mapped data. Other embodiments of this aspect include corresponding computer systems, apparatus, computer programs and computer-implemented methods.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a mobile device.

FIG. 2 is a diagrammatic representation of one embodiment of authenticating a browser extension with a service.

FIG. 3 is a diagrammatic representation of one embodiment of a flow for a service providing data to a client to allow a component of the client to authenticate with a service.

FIG. 4 is a diagrammatic representation of one embodiment of configuring a mobile device to allow a browser extension to authenticate with a service.

FIG. 5 is a diagrammatic representation of one embodiment of a computing environment.

### WRITTEN DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of the present disclosure provide mechanisms to enable a browser extension to authenticate with a service. In some embodiments, the browser extension can authenticate with the service without requiring that a mobile application directly pass authentication data to the browser extension and without requiring that the end-user input credentials to the browser extension.

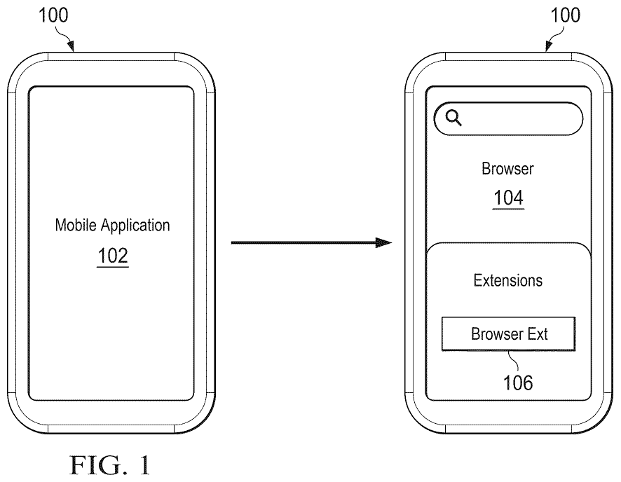

FIG. 1 is a diagrammatic representation of one embodiment of a mobile device 100, such as a smartphone, which runs a mobile operating system. The mobile device includes a mobile application 102 (e.g., a native mobile application) and a web browser 104 with an installed browser extension 106. The browser extensions extend the web-browsing experience in web browser 104 and can provide a wide range of functionality by, for example, leveraging web technologies and installed mobile applications.

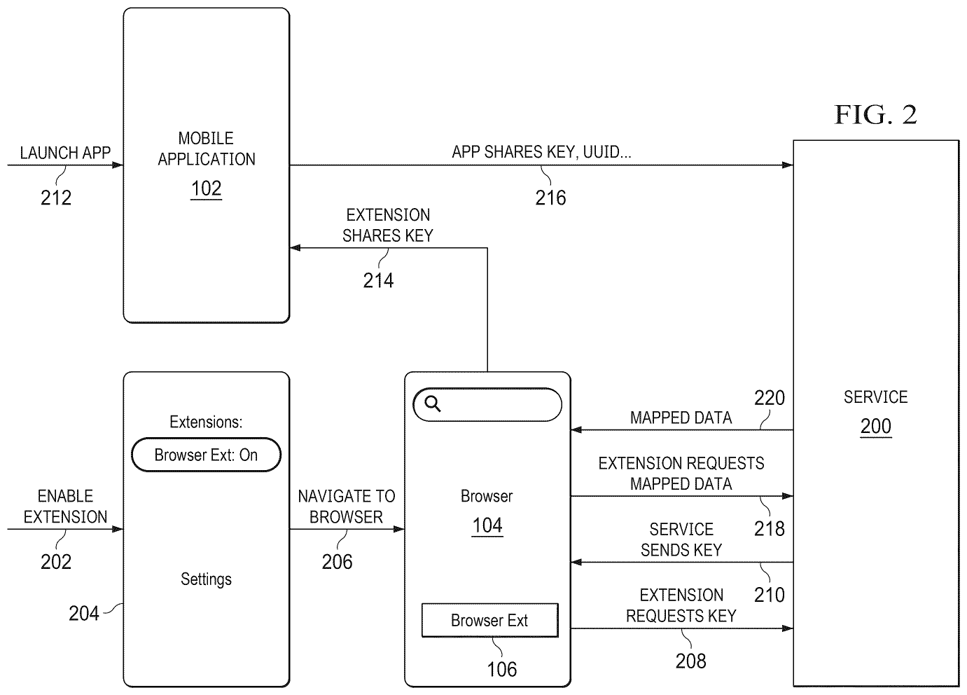

FIG. 2 is a diagrammatic representation of one embodiment of authenticating browser extension 106 with a service 200, such as a cloud service, without requiring that mobile application 102 directly pass credentials to browser extension 106 or that the end-user input credentials redundantly to browser extension 106.

According to one embodiment, for example, mobile application 102 is assigned a unique identifier, such as a universally unique identifier (UUID). The unique identifier may be used by the service 200 to identify requests as being associated with a particular user account with which mobile application 102 has authenticated. In some embodiments, service 200 associates the unique identifier with an account when the user installs and initially authenticates mobile application 102 with service 200.

In operation, the end-user installs extension 106 in browser 104 and configures the settings 204 of mobile device 100 to enable extension 106 (step 202). The user navigates to web browser 104 with browser extension 106 enabled (step 206). Responsive to the user navigating to web browser 104, browser extension 106 requests an authentication key from service 200 (step 208). Service 200 generates a unique authentication key for extension 106 and returns the key to extension 106 (step 210).

If it is not already running, the end-user launches mobile application 102 (step 212) and browser extension 106 shares the authentication key with mobile application 102 (step 214). Mobile application 102 sends the authentication key and additional data to be mapped to the authentication key to service 200 (step 216). According to one embodiment, the additional data includes a unique identifier and additional authentication data for use by browser extension 106 when authenticating with a service (e.g., service 200 or another service). The additional authentication data may include, for example, any application or user specific data for use during the process to authenticate browser extension 106 with the service. By way of example, but not limitation, the additional authentication data may include, for example, expiration time for the user, authentication credentials (username, password), or other authentication information to be used by browser extension 106 when authenticating with a service.

Service 200 maps data to the authentication key to the additional data to create mapped data. The mapped data may include additional data received from mobile application 102, generated by service 200, or otherwise provided for mapping to the authentication key. For example, service 200, according to one embodiment, maps the unique identifier and any additional authentication data provided by mobile application 102 to the authentication key.

Browser extension 106 requests mapped data from service 200 using the authentication key (step 218) and service 200 returns the data mapped to the authentication key to browser extension 106 (step 220). Browser extension 106 authenticates with mapped data received from the remote service 200. Browser extension 106 may, for example, include the mapped data in an authentication request to service 200 or another service. In addition, or in the alternative, to browser extension 106 including mapped data in the authentication request, browser extension 106 may generate authentication data from the mapped data and include the generated authentication data in the authentication request.

FIG. 2 is merely illustrative, and the disclosed subject matter is not limited to the ordering or number of steps illustrated. Embodiments may implement additional steps or alternative steps, omit steps, or repeat steps.

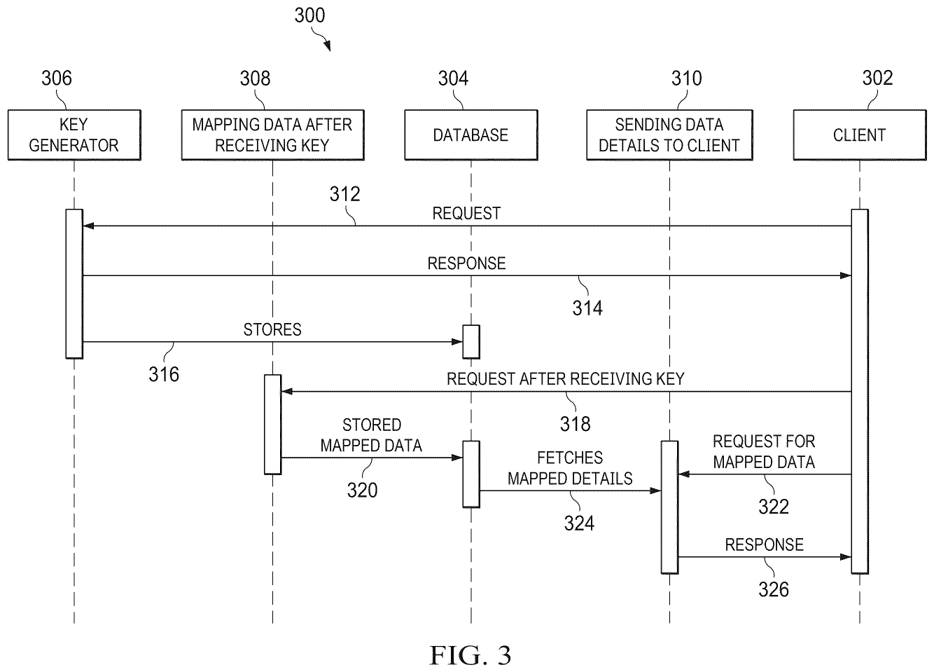

FIG. 3 is a diagrammatic representation of one embodiment of a flow for a service 300 providing data to a client 302 to allow a component of the client to authenticate with a service. In the illustrated embodiment, service 300 comprises a database 304, key generator 306, code 308 for mapping details to authentication keys, code 310 for sending mapped details to client 302. Service 300, in some embodiments, is a cloud-based service.

Service 300 receives a key generation request 312 from client 302 to generate an authentication key. Key generator 306 generates a unique authentication key and returns a response 314 to client 302 that includes the generated authentication key. Service 300 further stores the authentication key to database 304 (flow 316).

After returning the authentication key to client 302, service 300 receives a request 318 from client 302 to map additional data to the authentication key. In one embodiment, request 318 includes the authentication key, a unique identifier and additional authentication data to be mapped to the authentication key. According to one embodiment, the additional authentication data may include application or user specific data for use during a downstream process to authenticate a component of client 302, such as a browser extension, with a service. The additional authentication data may include, for example, authentication credentials (username, password), a user expiration time, or other authentication information that can be used when authenticating with a service. The additional authentication data will depend, for example, on the types of data required by the authentication process in which the data is to be used.

Service 300 services request 318 to map the additional data to the authentication key in database 304, thus creating mapped data for the authentication key (flow 320). According to one embodiment, for example, service 300 maps the unique identifier (e.g., the unique identifier of a mobile application) and any additional authentication data from request 318 to the authentication key.

After the data is mapped to the authentication key, service 300 receives a request 322 for the mapped data associated with the authentication key. In some embodiments, request 322 includes the authentication key. Service 300 services request 322 to fetch the data mapped to the authentication key from database 304 (flow 324) and send a response 326 to client 302 that includes the mapped data for the authentication key. The mapped data includes data that may be used by client 302 to authenticate with service 300 or, in some embodiments, another service.

According to one embodiment, client 302 is a mobile device that includes a native mobile application and a web browser with a browser extension and service 300 provides data to client 302 to enable the browser extension to authenticate with a service. In an even more particular embodiment, key generation request 312 is generated by and response 314 is returned to the web browser extension of client 302, request 322 for mapped data is generated by and response 326 is returned to the web browser extension, and request 318 is generated by the native mobile application.

FIG. 3 is merely illustrative, and the disclosed subject matter is not limited to the ordering or number of steps illustrated. Embodiments may implement additional steps or alternative steps, omit steps, or repeat steps.

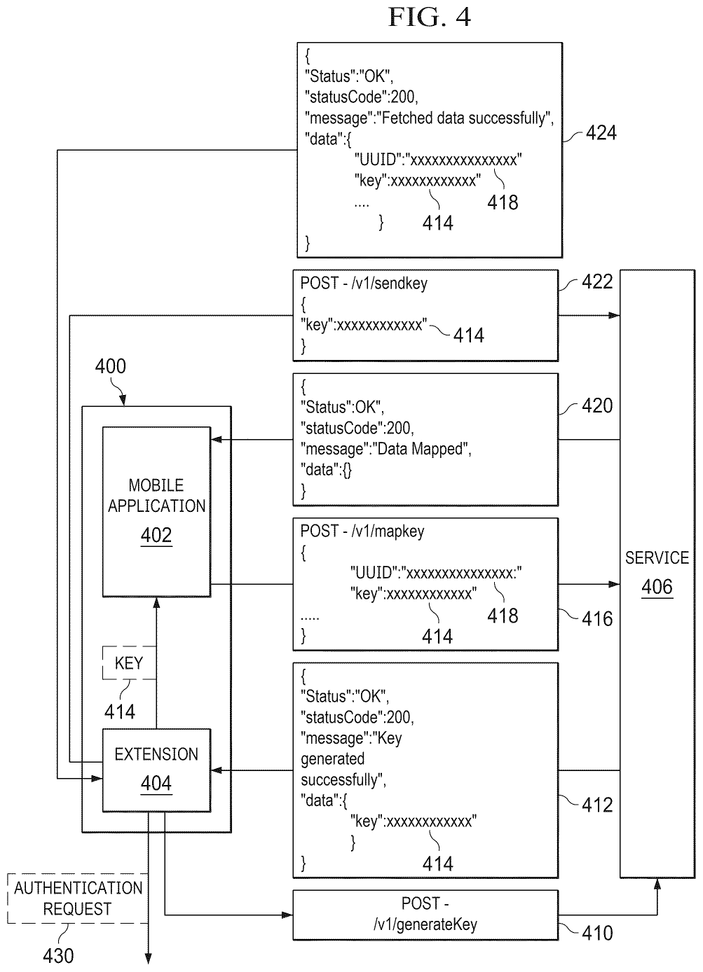

FIG. 4 is a diagrammatic representation of one embodiment of configuring a mobile device 400 to allow a browser extension 404 to authenticate with a service. In the embodiment of FIG. 4, mobile device 400 includes a mobile application 402 (e.g., a native mobile application) and a web browser having browser extension 404. Mobile application 402 has an assigned unique identifier (UUID) that is used by browser extension 404 during an authentication process.

In operation, browser extension 404 generates a key generation request 410 and sends key generation request 410 to service 406 to request an authentication key. Service 406 generates a unique authentication key and returns a response 412 that includes the generated authentication key 414. Browser extension 404 passes authentication key 414 to mobile application 402.

Mobile application 402 generates a request 416 to map additional data to authentication key 414 and sends request 416 to service 406. Request 416 includes the unique identifier (UUID) assigned to mobile application 402. Request 416 may also include additional authentication data to be mapped to the authentication key. According to one embodiment, the additional authentication data may include application or user specific data for use during the process to authenticate browser extension 404.

Service 406 maps the additional data from request 416 to authentication key 414 to create mapped data. For example, service 416 maps unique identifier (UUID) 418 to authentication key 414. According to one embodiment, the mapped data may also include additional authentication data received from mobile application 402 (e.g., authentication data included in request 416), generated by service 406, or otherwise provided for use by browser extension 404 when authenticating with a service. Service 406 returns a response 420 indicating whether the additional data was successfully mapped to the authentication key.

Browser extension 404 sends a request for mapped data 422 to service 406. Request for mapped data 422 includes authentication key 414. Responsive to request for mapped data 422, service 406 generates a response 424 to browser extension 404 that includes the data mapped to authentication key 414. For example, response 424 includes UUID 418 previously included in request 416 from mobile application 402. Response 424 may also include additional authentication data.

Browser extension 404 uses the mapped data to authenticate with service 406 or, in some embodiments, another service. For example, browser extension 404, in one embodiment, sends an authentication request 430 to a service (e.g., service 406 or another service) that includes any application or user specific data needed to authenticate browser extension 404 with the service. More particularly, in one embodiment, authentication request 430 includes the mapped data. For example, according to one embodiment, the authentication request 430 includes UUID 418 and additional authentication data, such as, an expiration time for the user, authentication credentials (username, password), or other authentication information. The authentication request, according to one embodiment, further includes authentication key 414.

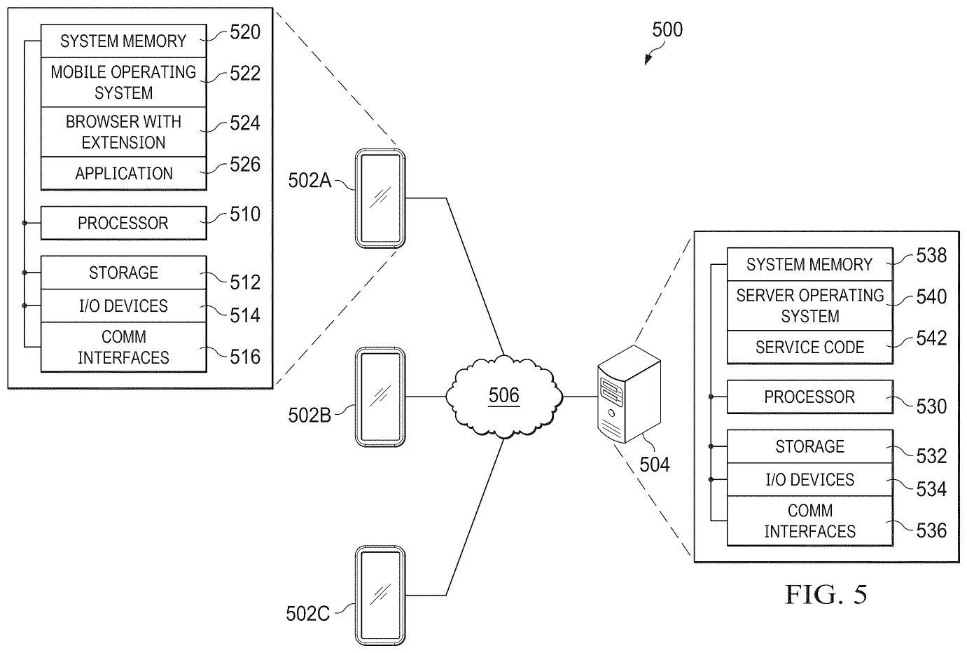

FIG. 5 is a diagrammatic representation of one embodiment of a computing environment 500 that includes a plurality of mobile devices (mobile device 502a, mobile device 502b, mobile device 502c are illustrated) connected to a server computer system 504 via a network 506. Server computer system 504, according to one embodiment, is a cloud computing system.

Mobile device 502a includes a processor 510 and memory 520. Depending on the exact configuration and type of mobile device, memory 520 (storing, among other things, executable instructions) may be volatile (such as RAM), non-volatile (such as ROM, flash memory, etc.), or some combination of the two. Further, mobile device 502a may also include storage devices 512, such as, but not limited to, solid state storage. Similarly, mobile device 502a may also have input device(s) and output device (I/O devices 514) such as keyboard, mouse, pen, voice input, touch screen, speakers. Mobile device 502a further includes communications interfaces 516, such as a cellular interface, a Wi-Fi interface, or other interfaces.

Mobile device 502a includes at least some form of non-transitory computer-readable media. The non-transitory computer-readable readable media can be any available media that can be accessed by processor 510 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, a number of program modules and data files may be stored in system memory 520. While executing on processor 510, program modules (e.g., applications, Input/Output (I/O) management, and other utilities) may perform processes including, but not limited to, one or more of the stages of the operational methods described with respect to mobile device 100, client 302, or mobile device 400. In one embodiment, system memory 520 stores a mobile operating system 522, a web browser 524 with a browser extension (e.g., browser extension 106, browser extension 404, or other browser extension), and a mobile application 526, such as mobile application 102 or mobile application 402. According to one embodiment, the mobile operating system 522 is an IOS operating system by APPLE, INC. of Cupertino California, USA, web browser 524 is the SAFARI web browser from APPLE, INC. (all trademarks, tradenames, service marks and the like used herein are the property of their respective owners), and mobile application 526 is a native mobile application designed to run on the IOS operating system.

Mobile applications and browser extensions can provide a wide range of functionality. As just one example, a mobile application, such as mobile application 102, mobile application 402, or mobile application 526 may be a web security application and a browser extension, such as browser extension 106, browser extension 404, or an extension of web browser 524 may be a security browser extension executable to read and modify webpage content returned by websites to the browser.

System memory 520 may include other program modules such as program modules to provide analytics or other services. Furthermore, the program modules may be distributed across computer systems in some embodiments.

Server computer system 504 includes a processor 530 and memory 538. Depending on the exact configuration and type of computer system 504, memory 538 (storing, among other things, executable instructions) may be volatile (such as RAM), non-volatile (such as ROM, flash memory, etc.), or some combination of the two. Further, server computer system 504 may also include storage devices 532. Similarly, server computer system 504 may also have input device(s) and output device (I/O devices 534) such as keyboard, mouse, pen, voice input, touch screen, speakers. Server computer system 504 further includes communications interfaces 536, such as a cellular interface, a Wi-Fi interface, or other interfaces.

Server computer system 504 includes at least some form of non-transitory computer-readable media. The non-transitory computer-readable readable media can be any available media that can be accessed by processor 530 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

A number of program modules and data files may be stored in system memory 538. While executing on processor 530, program modules (e.g., applications, Input/Output (I/O) management, and other utilities) may perform processes including, but not limited to, one or more of the stages of the operational methods described with respect to service 200, service 300, or service 406. In one embodiment, system memory 520 stores a server operating system 540 and an application 542 that is executable to provide a service such as service 200, service 300, or service 406. System memory 538 may include other program modules such as program modules to provide analytics or other services. Furthermore, the program modules may be distributed across computer systems in some embodiments.

Server computer system 504 may be a single computer operating in a networked environment using logical connections to remote computers. The remote computer may be, for example, a mobile device, such as mobile device 502a, mobile device 502b, or mobile device 502c. The logical connections may include any method supported by available communications media. Server computer system 504, in one embodiment, may be a cloud computing system that comprises multiple server computers.

Some embodiments may be practiced in an electrical circuit comprising discrete electronic elements, packaged or integrated electronic chips containing logic gates, a circuit utilizing a microprocessor, or chip single chip containing electronic elements or microprocessors. For example, examples of mobile device processing or server computer system processing may be practiced via a system-on-a-chip (SOC) where each or many of the components of mobile device 502a or server computer system 504 may be integrated onto a single integrated circuit. Such an SOC device may include processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment on the single integrated circuit (chip).

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A system for browser extension authentication comprising:
a mobile device comprising:
a mobile device processor;
a mobile device memory storing applications, the applications comprising:
a web browser comprising a browser extension that is executable by the mobile device processor, the browser extension comprising instructions for:
sending a request for an authentication key to a remote service;
receiving the authentication key from the remote service;
providing the authentication key to a native mobile application;
requesting mapped data using the authentication key, the mapped data comprising a unique identifier;
receiving the mapped data from the remote service; and
authenticating using the mapped data received from the remote service; and
the native mobile application, wherein the native mobile application is executable by the mobile device processor and comprises instructions for:
receiving the authentication key from the browser extension;
providing data to be mapped to the authentication key as the mapped data to the remote service, wherein the data to be mapped to the authentication key comprises the unique identifier;
a server communicatively coupled to the mobile device by a network, the server comprising:
a server processor;
a server memory storing code executable by the server processor to provide the remote service, the code comprising instructions for:
generating the authentication key;
returning the authentication key to the browser extension;
receiving the data to be mapped to the authentication key from the native mobile application;
mapping the data to be mapped to the authentication key to the authentication key as the mapped data; and
providing the authentication key and the mapped data to the browser extension.

2. The system of claim 1, wherein the data to be mapped to the authentication key comprises additional authentication data, wherein the mapped data comprises the additional authentication data, and wherein the additional authentication data comprises at least one of user specific data or data specific to the native mobile application.

3. The system of claim 1, wherein the browser extension requests the authentication key from the remote service in response to a user navigating to the web browser on the mobile device.

4. The system of claim 1, wherein authenticating using the mapped data comprises sending an authentication request to the remote service, the authentication request comprising the authentication key and the mapped data.

5. The system of claim 1, wherein the browser extension is a browser security extension executable to read webpage content returned by websites to the web browser.

6. A computer-implemented method for browser extension authentication, the method comprising:
requesting by a browser extension of a web browser on a mobile device, an authentication key from a remote service;
receiving by the browser extension, the authentication key from the remote service;
the browser extension providing the authentication key to a native mobile application on the mobile device;
requesting by the browser extension, from the remote service, mapped data that is mapped to the authentication key, the mapped data comprising a unique identifier provided by the native mobile application;
receiving by the browser extension, from the remote service, the mapped data; and
authenticating the browser extension using the mapped data received from the remote service.

7. The computer-implemented method of claim 6, wherein the mapped data comprises additional authentication data, and wherein the additional authentication data comprises at least one of user specific data or data specific to the native mobile application.

8. The computer-implemented method of claim 6, wherein the browser extension requests the authentication key from the remote service in response to a user navigating to the web browser on the mobile device.

9. The computer-implemented method of claim 6, wherein authenticating using the mapped data comprises sending an authentication request to the remote service, the authentication request comprising the authentication key and the mapped data.

10. The computer-implemented method of claim 6, further comprising the native mobile application sending data to be mapped to the authentication key to the remote service for mapping to the authentication key as the mapped data.

11. The computer-implemented method of claim 10, wherein the data to be mapped to the authentication key comprises additional authentication data, and wherein the additional authentication data comprises at least one of user specific data or data specific to the native mobile application.

12. The computer-implemented method of claim 10, further comprising:
the remote service receiving the data to be mapped to the authentication key from the native mobile application; and
the remote service generating the mapped data, wherein generating the mapped data comprises mapping the data be mapped to the authentication key to the authentication key.

13. The computer-implemented method of claim 6, further comprising:
the remote service generating the authentication key in response to the browser extension requesting the authentication key; and
the remote service generating the mapped data, wherein generating the mapped data comprises mapping the unique identifier to the authentication key.

14. A computer program product comprising a non-transitory computer-readable medium storing thereon data embodying a browser extension that is executable by a mobile device, the browser extension comprising instructions for:
sending a request for an authentication key to a remote service;
receiving the authentication key from the remote service;
providing the authentication key to a native mobile application on the mobile device;
requesting mapped data from the remote service using the authentication key, the mapped data comprising a unique identifier provided by the native mobile application;
receiving the mapped data from the remote service; and
authenticating using the mapped data received from the remote service.

15. The computer program product of claim 14, wherein authenticating using the mapped data comprises sending an authentication request to the remote service, the authentication request comprising:
the authentication key; and
the mapped data.

16. The computer program product of claim 14, wherein the browser extension is a browser security extension executable to read webpage content returned by websites to a web browser.

17. A computer program product comprising a non-transitory computer-readable medium storing thereon data embodying a native mobile application that is executable by a mobile device, the native mobile application comprising instructions for:
receiving an authentication key from a browser extension on the mobile device; and
sending a mapping request to a remote service, the mapping request comprising data to be mapped to the authentication key by the remote service as mapped data for use by the browser extension in authenticating, wherein the data to be mapped includes a unique identifier.

18. The computer program product of claim 17, wherein the mapping request comprises the authentication key.

19. The computer program product of claim 18, wherein the data to be mapped to the authentication key comprises additional authentication data.

20. The computer program product of claim 19, wherein the additional authentication data comprises at least one of data specific to the native mobile application or data specific to a user.
